(19) United States
(12) Patent Application Publication
(10) Pub. No.: US 2012/0041845 A1
(43) Pub. Date: Feb. 16, 2012

(54) SYSTEM AND METHOD FOR ENABLING CUSTOMERS TO PERFORM SELF CHECK-OUT PROCEDURES IN A RETAIL SETTING

(75) Inventor: Leigh M. Rothschild, Sunny Isles Beach, FL (US)

(73) Assignee: LMR INVENTIONS, LLC, Sunny Isles Beach, FL (US)

(21) Appl. No.: 12/854,256

(22) Filed: Aug. 11, 2010

(51) Int. Cl. G06Q 30/00

(52) U.S. Cl. 705/26.81; 235/383; 705/26.1

(57) ABSTRACT

Systems and methods are provided for enabling a customer to perform a self check-out procedure during a purchasing transaction. In one embodiment, among others, a software program is stored on a computer-readable medium and configured to be executed by a processing device. The software program includes logic adapted to enable a user of a portable customer device to utilize the portable customer device to scan a code associated with a product. The software program also includes logic adapted to enable the user to add the product to an electronic shopping cart and logic adapted to instruct the user to physically add the product to a physical cart.

### BACKGROUND

1. Field

The present disclosure relates generally to retail purchases, and more particularly, to systems and methods for allowing a customer to utilize a portable electronic device to purchase products using a self check-out procedure.

2. Description of the Related Art

Portable digital devices are now common. Examples include various Windows™ Pocket PC devices which have an operating system created by Microsoft Corporation of Redmond, Wash. Other examples include various mobile phone devices including many that have built-in cameras, scanning devices, and other types of imaging devices. Still other portable digital devices include portable media players from Creative Media of Singapore, Samsung of South Korea, Archos, Inc. of Irvine, Calif. and Apple Computers, Inc. of Cupertino, Calif. Additionally, Sony of New York and Japan manufacture a portable game playing device called the Sony PSP™ (PlayStation Portable).

Increasingly, many of these portable media devices include means of transmitting and receiving digital data. Various communications technologies are frequently built into these devices. Examples of portable communicating devices include mobile phones which employ GSM, CDMA, W-CDMA, and FOMA technology, among other standards, to send and receive data in addition to handling voice communications. Many of the portable media devices also include transmission capabilities including WiFi (IEEE 802.11a, b, g and x among others), Bluetooth, infrared, etc. to allow the user to transmit and receive digital data over relatively short distances. The Sony PSP™ device, for example, includes Wi-Fi (i.e., IEEE 802.11b) to transmit and receive digital data.

### SUMMARY

Systems and methods are provided for enabling a customer to perform a self check-out routine when purchasing goods or services. In one embodiment, a software program, which is stored on a computer-readable medium and configured to be executed by a processing device, is provided. The software program includes logic adapted to enable a user of a portable customer device to utilize the portable customer device to scan a code associated with a product. The software program also includes logic adapted to enable the user to add the product to an electronic shopping cart and logic adapted to instruct the user to physically add the product to a physical cart.

In some embodiments, a retail system may comprise a retailer device and a receipt verification device in communication with the retailer device. The retailer device may be associated with a business that allows a customer to purchase goods or services. The retailer device comprises, among other things, a receiver and a processor. The receiver is configured to receive signals from a portable customer device associated with the customer, the signals related to a list of items to be purchased by the customer. The processor may be configured to coordinate with the portable customer device to complete a purchase of the listed items. The processor is further configured to create an electronic receipt containing information of the purchase and create a transaction code corresponding to the electronic receipt. The receipt verification device comprises an input device configured to enable store personnel to obtain the transaction code and a display device configured to display an electronic receipt corresponding to the obtained transaction code.

According to various methods of the present disclosure, one embodiment of a method includes the step of coordinating with a customer using a portable customer device to perform a self check-out procedure for making a purchase from a retail establishment offering merchandise for sale. The method also includes creating an electronic receipt summarizing the purchase and a transaction code to be associated with the electronic receipt. The method includes the steps of enabling store personnel to obtain the transaction code from the customer and displaying an electronic receipt associated with the obtained transaction code to allow the store personnel to compare the merchandise listed on the electronic receipt with merchandise that the customer is taking from the retail establishment.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1A is a front view of a portable electronic device according to various embodiments of the present disclosure;

FIG. 1B is a rear view of the portable electronic device of FIG. 1A;

FIG. 2 is a block diagram of various modules included in the portable electronic device illustrated in FIG. 1 according to various embodiments of the present disclosure;

FIG. 3 is a diagram of a system enabling communication among a number of components;

FIG. 4 is a diagram of a retail system according to various embodiments of the present disclosure;

FIG. 5 is a flow diagram illustrating a method for presenting instructions regarding a self check-out procedure;

FIGS. 6A and 6B collectively illustrate a flow diagram of a method for utilizing a portable customer device to perform a self check-out procedure according to various embodiments of the present disclosure;

FIG. 7A is a flow diagram illustrating a method for performing a self check-out procedure according to various embodiments of the present disclosure;

FIG. 7B is a flow diagram illustrating a method for handling requests to view product information;

FIG. 7C is a flow diagram illustrating a method for handling requests to view prior electronic receipts; and

FIG. 8 is a flow diagram illustrating a method for verifying a retail purchase according to various embodiments of the present disclosure.

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail.

Systems and methods for enabling self check-out procedures in a retail environment are provided. The systems and methods allow a user to purchase items in a retail establishment using a self check-out procedure without the assistance of store personnel. Generally, the self check-out procedure in accordance with the embodiments described in the present disclosure involves enabling a customer to utilize his or her own portable electronic device to select items for purchase and coordinate with a retailer device to finalize a financial transaction to pay for the items being purchased. One advantage of self check-out procedures is that a retailer may hire fewer employees to conduct the check-out procedures on behalf of the customers, thereby saving employment costs. Another advantage is that it may often be quicker for customers to perform the check-out procedures themselves without waiting in lines for available store personnel to check them out.

In operation of the systems and methods of the present disclosure, a customer using his or her own portable electronic device may select one or more products (e.g., by scanning barcodes or other symbology associated with the respective products). The scanning process identifies the merchandise as something that the customer wishes to purchase. According to various implementations in which a customer does not have a portable digital device with scanning capabilities, the store may offer portable self-scanning terminals that the customers may use to identify products that he or she may wish to purchase from the retail establishment. The self-scanning device may be a Motorola/Symbol Technologies MC17 Portable Self-scanning Terminal. In some embodiments, the store may offer one or more kiosks that may be used for self check-out. Kiosk systems are available from Motorola/Symbol Technologies, among other companies.

Several technology solutions are available to enable a customer to select merchandise. One such solution may be a device containing a charge couple device (CCD) or camera, where the user may scan or take a picture of a barcode placed on or associated with a product. Portable devices (e.g., IPhone from Apple, Android from HTC, etc.) may include decoding software to be used to decode the scanned barcode symbology. Another solution may be a device containing a user interface allowing user keyboard input, where the user may input the name of the item into the portable device. The portable device may contain voice recognition software, where the user may speak the name of the product into the portable device. In a further embodiment, the merchandise may contain Radio Frequency Identification (RFID) tags used to identify the product to a reader device. Furthermore, if the portable device contains an image capture device (e.g., a camera) and character recognition software, the user may take a picture of the product and the character recognition software may be used to decode the image and/or name of the product.

According to various embodiments of the present disclosure, various portable devices already owned by many customers can be enhanced with software applications to enable a self check-out procedure at a retail establishment without the need for either a store kiosk or a store-provided scanner. One advantage for the retailer, among others, is that the customers use their own personal devices and the retailer does not need to buy, maintain, repair and/or replace specialized check-out devices. An advantage to the customers is that they may already be familiar with their own devices, as opposed their likely unfamiliarity with the store's scanning devices. Another advantage for the customer when he or she is already carrying the portable electronic device is that he or she does not need to hassle with the process of being issued a store device. The customers may also benefit from these systems and methods by not being required to carry credit and/or debit cards, because information for one or more financial accounts may be stored in the customer's device and accessed as needed to complete a purchase.

The portable electronic device may use any suitable communications protocols including but not limited to WiFi (a, b, c d, n, x), cellular communications such as GSM, CDMA, FOMA, etc., infrared communications, cabled communications, Bluetooth communications, satellite communications, etc. In the environment of a retail establishment, the portable device may simply utilize short range communication protocols for communicating with a computer located within or near the retail establishment. When the customer is finished shopping and is ready to check out, the customer may use the self check-out procedures as described in the present disclosure.

An issue that may arise with respect to self check-out procedures is the matter of security. When a customer is allowed to self check-out, the retail establishment usually wants to know whether or not the customer has accurately accounted for every retail item and is being charged for the items being carried out of the store. If the customer fails to account for one or more items, either by intention or inadvertently, the retailer might not be properly paid for the items.

In some environments, a paper receipt is printed for the customer. When the customer is preparing to exit the store with merchandise, a store employee may be assigned to compare the paper receipt with the merchandise to make sure the items on the receipt matches the item being taken from the store. One disadvantage of this procedure is that it relies on a paper receipt being generated, which cannot be generated by typical portable devices (e.g., cellular phones), thereby complicating the self check-out procedure using the portable electronic device. Another disadvantage is that a paper receipt can easily be lost, which may make the process of returning merchandise more difficult. Also, a paper receipt may be easily tampered with to mislead retail personnel.

To solve the issues that may arise with security for self check-out and issues involving paper receipts, the embodiments of systems and methods of the present disclosure provide electronic receipts that may be stored in a database. Also, these electronic receipts may be displayed on a receipt verification device within the retail store. Security personnel may be trained to compare the electronic receipt displayed on the receipt verification device with the products that the customer is carrying out of the store to determine if there are any discrepancies. The security personnel may be positioned at the exit of the store or at some other strategic location to verify the match between receipts and merchandise being removed from the store. Advantages of electronic receipts are that they are not easily lost and may be easily retrieved by electronic means. Also, the purchases summarized on electronic receipts may be easily converted for use by accounting programs, such as Microsoft Money, Quicken, TurboTax, etc.

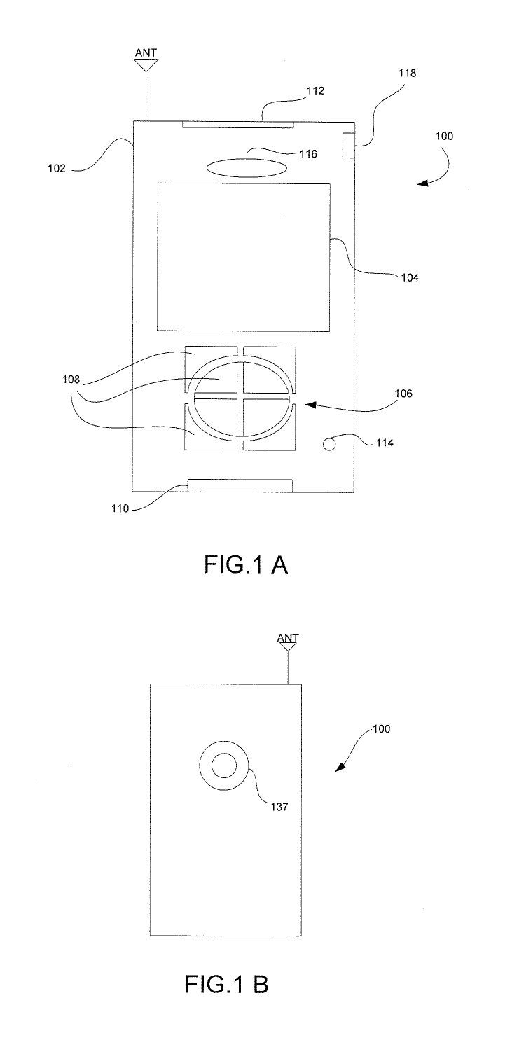

FIG. 1A shows an embodiment of a portable electronic device 100 for receiving and transmitting wireless communication signals. In accordance with various embodiments of the present disclosure, the portable electronic device 100 includes various electrical components, which will be described in detail below, disposed in a generally rectangular housing 102. A display module 104 is provided for displaying video and image media content, such as movies, animations, etc. A speaker 116 is provided for producing audio, e.g., music or a soundtrack associated with a video. An audio port 118 may be configured to receive a plug or connector from a headphone, stereo system, etc., to stream the audio to the connected device. It is to be appreciated that when an external device is connected to the audio port 118, the speaker 116 may be disabled. Input module 106 includes a plurality of buttons 108 for inputting data and navigating through a plurality of menus. A touch screen overlaid upon the display module 104 may also be coupled to the input module for facilitating user input. The portable electronic device 100 further includes a storage module 110 for storing a plurality of content and a transmission module 112 for transmitting/receiving data and/or content to another device, e.g., a personal computer, a personal digital assistant (PDA), a server residing on the Internet, etc. Optionally, the portable electronic device 100 may include a microphone 114 for acquiring audio from the user of the device to input data. In some embodiments, the portable electronic device 100 may include a scanning device (not shown).

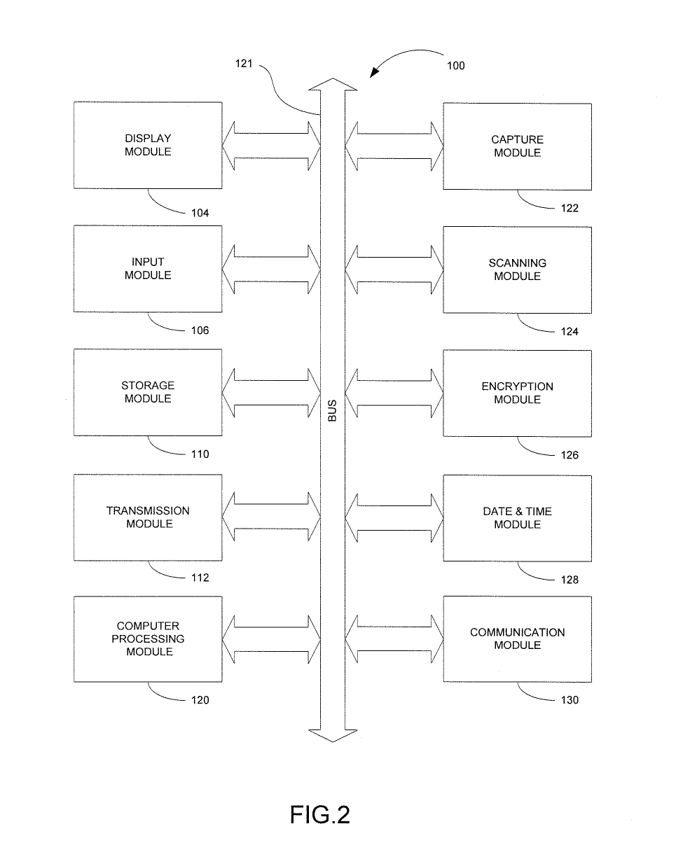

Referring to FIG. 2, the various components of the device 100 will now be described. In this embodiment, the device 100 contains a computer processing module 120 (e.g., a microprocessor). The computer processing module 120 may use computer software instructions that have been programmed into the module and conventional computer processing power to interact and organize the traffic flow between the various other modules. It is to be understood that the present disclosure may be implemented in various forms of hardware, software, firmware, special purpose processors, or a combination thereof. A system bus 121 couples the various components shown in FIG. 2 and may be any of several types of bus structures including a memory bus or memory controller, a peripheral bus, and a local bus using any of a variety of bus architectures. The device 100 also includes an operating system and micro instruction code preferably residing in read only memory (ROM) (not shown). The various processes and functions described herein may either be part of the micro instruction code or part of an application program (or a combination thereof) which is executed via the operating system. Exemplary operating systems include but are limited to SymbianOS, Windows Mobile/Windows CE, Palm OS, Linux, Blackberry OS, Android OS, BREW, etc., which have been developed for mobile computing applications and can handle both data computing and communication applications, e.g., voice communications.

It is to be further understood that because some of the constituent device components and method steps depicted in the accompanying figures may be implemented in software, the actual connections between the device components (or the process steps) may differ depending upon the manner in which the present disclosure is programmed. Given the teachings of the present disclosure provided herein, one of ordinary skill in the related art will be able to contemplate these and similar implementations or configurations of the present disclosure.

The computer processing module 120 may further include, in addition to a microprocessor, a digital signal processor (DSP) for decoding stored audio, video and photo files to be played on the portable electronic device 100. As is known in the art, the DSP may include several known decompression algorithms for decompressing stored media content, e.g., a MP3 file. The device 100 of the present disclosure is configured to support various file types including but not limited to Microsoft Windows Media Video files (.wmv), Microsoft Photo Story files (.asf), Microsoft Windows Media Audio files (.wma), MP3 audio files (.mp3), JPEG image files (.jpg, .jpeg, .jpe, .jfif), MPEG movie files (.mpeg, .mpg, .mpe, .m1v, .mp2v .mpeg2), Microsoft Recorded TV Show files (.dvr-ms), Microsoft Windows Video files (.avi) and Microsoft Windows Audio files (.wav).

The device 100 also contains a display module 104 for displaying digital information such as video files, image files, text files, etc. The display module 104 (and any corresponding display devices) may be configured in any suitable form, including, for example, Liquid Crystal Displays (LCD), Light emitting diode displays (LED), Cathode Ray Tube Displays (CRT) or any other type of display currently existing or existing in the future. The display module 104 may also include an audio output device, e.g., a speaker 116, audio port 118, etc., allowing the user to also hear audio output from the device 100, e.g., audio associated with a video, a MP3 file, etc.

The device 100 of the present disclosure contains a user input module 106 to either receive user instructions via text input by the way of buttons 108, a standard keyboard interface coupled to the device, or a character recognition capture device which translates user text input into alphanumeric characters. Preferably, the character recognition device is a touch screen which overlays the display module 104 and text may be entered via a pen-like stylus. Such input devices are standard and currently available on many electronic devices including portable digital assistants (PDAs) and cellular telephones. Optionally, microphone 114 may be further coupled to the input module 106 for capturing any audio information spoken by the user and the input module may further include an analog-to-digital (ND) converter for converting the spoken audio information into a digital format. Furthermore, the input module may include a voice recognition processor that translates the digital human voice into alpha numeric characters for user input. The user may utilize the user input module 106 to enter various data, for example, to add or remove merchandise from a virtual shopping cart, requesting information about merchandise, requesting to view a prior electronic receipt, etc.

The storage module 110 includes internal storage memory (e.g., random access memory (RAM)) or removable memory (e.g., magnetic storage memory), optical storage memory (e.g., various types of CD and DVD media), solid-state storage memory (e.g., a CompactFlash card, a Memory Stick, SmartMedia card, MultiMediaCard (MMC), SD (Secure Digital) memory, etc.), or any other memory storage that exists currently or will exist in the future.

The transmission module 112 enables the device 100 to transmit or transfer information to other computing devices and to receive information from other computing devices, e.g., digital media files, codes to unlock downloaded media, encryption/decryption keys, etc. The transmission module 112 may perform its functionality by hardwired and/or wireless connectivity. The hardwire connection may include but is not limited to hard wire cabling, e.g., parallel or serial cables, USB cable, Firewire (1394 connectivity) cables, etc., and the appropriate ports. Wireless connections may operate under any various wireless protocols including but not limited to Bluetooth™ interconnectivity, infrared connectivity, radio transmission connectivity including computer digital signal broadcasting and reception commonly referred to as Wi-Fi or 802.11.X (where x denotes the type of transmission), satellite transmission or any other type of communication protocols or systems currently existing or to be developed for wirelessly transmitting data. The transmission module 112 may compress and encode the encrypted information for transmission using any suitable wireless communication technology. In one embodiment, antenna ANT is coupled to the transmission module 112 for extending the wireless transmission range of the device 100.

A capture module 122 may be provided to capture an image desired by the user in digital form, e.g., an image of a product, a barcode, etc. The capture module 122 includes an image sensor, an analog-to-digital (A/D) converter and a digital signal processor (DSP). Referring to FIG. 1B, when a user desires to capture an image, a lens 137 disposed on a rear or front side of the device is aimed at a subject of the image and is used in conjunction with display module 104 for positioning a subject of the image in lieu of a viewfinder. Light is allowed to enter through the lens 137 and shine on the image sensor, e.g., a charge-coupled device (CCD) or complimentary metal-oxide semiconductor (CMOS). The image sensor includes preferably millions of photosensors, e.g., pixels, wherein each pixel absorbs the light and transforms the light into an electric charge proportional to the intensity of light. Each charge is transmitted to an A/D converter where the charge is converted into a digital value representing the color the pixel will be, e.g., representing different intensities of red, green and blue. The digital values are then passed to the digital signal processor which enhances the image, compresses it and then stores it in a digital file format in the storage module 110.

In other embodiments, the device 100 further includes an integrated scanning module 124 for scanning a symbology (e.g., a barcode) on a product. The scanning module 124 may contain a light source, e.g., LED, and a photocell coupled to the computer processing module 120, or alternatively, includes a separate decoder engine that decodes the data received by the photocell before sending it to the computer processing module 120. Knowledge of the art reveals that many different types of scanners currently exist and the inventor realizes that the type of scanner would depend upon the type of symbology that is utilized in the printed images. The symbology may be in any form currently practiced in the art including barcodes (e.g., UPC, EAN, PDF417, etc.), photosymbols, standard or specialized text, etc., or any future type of symbology.

It is to be appreciated that the capture module 122 may also be used in conjunction with the scanning module 124 to read symbology associated with a product. Here, the capture module 122 acquires an image of the symbology and the scanning module 124 may further include a digital signal processor executing an algorithm for deciphering or decoding the symbology from the captured image. The use of an image sensor to read symbology, e.g., a barcode, is known in the art and systems employing such technology are commercially available from Symbol Technologies of New York and Neomedia of Georgia.

The device 100 may also include an encryption module 126. The encryption module 126 may be configured to use conventional code encryption algorithms currently in use or that will be in use in the future such as symmetric-key algorithms, e.g., DES, Triple-DES, Blowfish, RC2, RC4, RC5, etc, and asymmetric-key algorithms, e.g., Diffie-Hellman, RSA, ElGamal, etc., to decrypt locked digital media content files that are stored in the storage module 110. The encryption module 126 may also encrypt payment information of a user before the payment information is transmitted to another device or server.

Furthermore, the device 100 includes a date and time module 128. The date and time module 128 may use standard computer chip processing technology widely in use, e.g., a crystal, or alternatively, input from a GPS receiver, or remote server to supply the date and time.

In one embodiment, the device 100 according to the principles of the present disclosure may be embodied as a mobile phone including the modules and architecture illustrated in FIG. 2. In this embodiment, microphone 106 is further coupled to a communication module 130 for encoding a user's speech to be transmitted via antenna ANT using CDMA, PCS, GSM or any other known wireless communication technology. The user may enter phone numbers to be dialed via the touch screen, or alternatively, as is known in the mobile phone art, the device 100 may include a full QWERTY keyboard as an input module to enter text information. In addition to producing audio from audio or multimedia content, speaker 116 may be coupled to the antenna ANT and a decoder for receiving and decoding voice communication from another mobile phone.

It is to be appreciated that the communication module 130 may include a single integrated circuit chip to perform data transfer and voice communications or a single module including a separate data transfer chip, e.g., a WiFi transceiver, and a separate voice communication chip, e.g., a CDMA chip. In one embodiment, the communication module operates on the wireless GPRS (General Packet Radio Service) data protocol or a 3G protocol such as W-CDMA, CDMA2000 and TD-SCDMA. Both the GPRS and 3G protocols have the ability to carry both voice and data over the same service.

It is to be appreciated that the device 100 described above is an exemplary device and may include all or a portion of the modules described above. Furthermore, it is to be appreciated that various types of portable electronic devices (e.g., mobile phones, personal digital assistant (PDA), digital media playback device, etc.) may be used in accordance with the principles of the systems and methods of the present disclosure described herein.

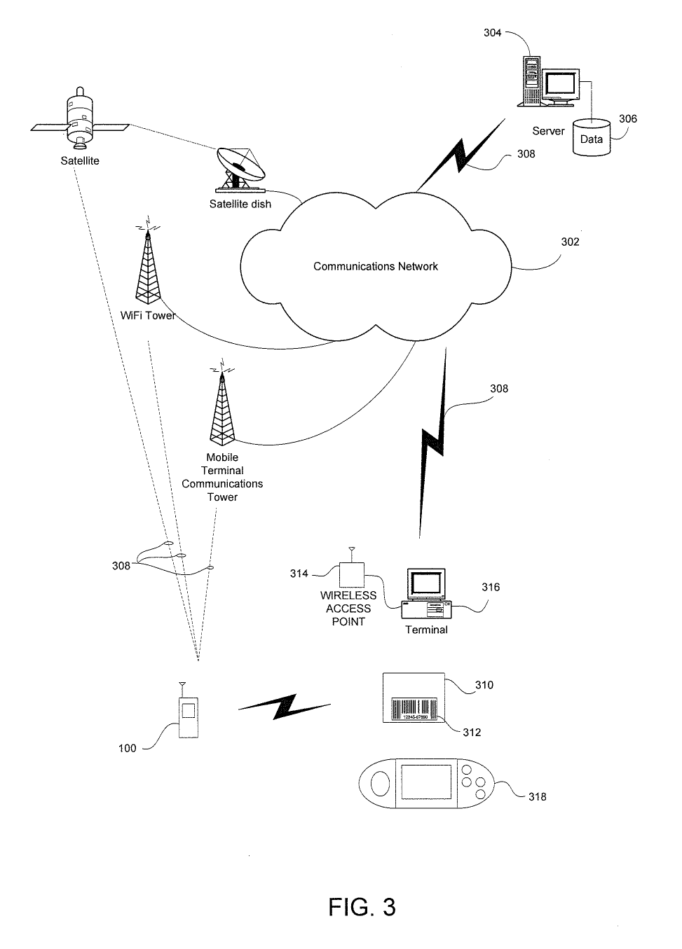

Systems and methods for enabling self check-out procedures in a retail purchase transaction are described in relation to FIGS. 3-7. Referring to FIG. 3, a system in accordance with the present disclosure is illustrated. The system includes the portable electronic device 100 as described above. The device 100 may be configured to communicate with a server 304 (or other devices in the system) via a communication network 302. The device 100 and server 304 may be connected to the communications network 302, e.g., the Internet, by any known means, for example, a hardwired or wireless connection 308, such as dial-up, hardwired, cable, DSL, satellite, cellular, PCS, wireless transmission (e.g., 802.11a/b/g), etc. It is to be appreciated that the network 302 may be a local area network (LAN), wide area network (WAN), the Internet or any known network that couples a plurality of computers to enable various modes of communication via network messages. Furthermore, the server 304 may communicate using the various known protocols such as Transmission Control Protocol/Internet Protocol (TCP/IP), File Transfer Protocol (FTP), Hypertext Transfer Protocol (HTTP), etc. and secure protocols such as Internet Protocol Security Protocol (IPSec), Point-to-Point Tunneling Protocol (PPTP), Secure Sockets Layer (SSL) Protocol, etc. The server 304 further includes a storage medium 306 for storing a database, which may include data related to electronic receipts for one or more stores. The storage medium 306 may also store data related to information about the products that are sold at the stores.

The products sold at the stores may include any types of goods and/or services (e.g., electronics, audio and/or video media, clothing, appliances, food, hardware, various services, etc.). As will be appreciated from the description below, a unique identification code is associated with each product to identify specific items and may take many forms, such as a barcode number, a UPC number, an alphanumeric number assigned to the product, a name of the article (e.g., “Batman Begins DVD”), etc. The identification codes may be attached to or printed on the products or in some other way associated with the products.

The user may utilize the portable digital device 100 to identify the product. For example, if the product 310 includes a barcode 312, the device 100 may be configured to scan the barcode 312 with the scanning module 124 and decode the barcode to acquire an identification code of the article. Alternatively, the device 100 may be configured to capture an image of the barcode using the capture module 122 and decode the barcode to acquire an identification code of the article. Furthermore, the user can also take a picture of the product via the capture module 122. Then using standard and existing computer processing power and software solutions such as Attrasoft Image recognition software, or optical character recognition software (OCR software such as OmniPage or ReadIris) the image or name of the product is decoded and the identity of the product is resolved.

In another embodiment, the user may enter the identification code of the article via a user interface including input module 106. If the device contains a user interface allowing user keyboard input, the user may input the name of the article into the portable device. The user may also speak the name of the product into the portable device via the microphone 114 and the audio signals may in turn be processed into digital form via speech recognition software.

In a further embodiment, the products may contain Radio Frequency Identification (RFID) tags. The portable digital device 100 may contain an RFID reader to resolve the identity of the product.

In another embodiment, the name or identification code of at least one product may be broadcast via a Wi-Fi wireless access point 314 over a predetermined range. The device may receive this transmission via transmission module 112 and may present a listing of content to the user via the display module 104. The user may then select an article of interest. An example of this embodiment would be in a retail store, e.g., a movie rental store, where a list of new movie releases is continuously broadcast in the store via a wireless access point coupled to a server or terminal 316 in the store. This list would only be available when within the confines of the store. The device would present this list to the user and the user may select a movie of interest wherein the identification code for the movie, i.e., the product, would be identified via the terminal 316.

Furthermore, the name or identification code of a product may be broadcast from another mobile device, e.g., a gaming device 318. Here, a user approaches a second user having a gaming device 318 having at least one electronic game either stored in memory or currently being played. The gaming device 318 may broadcast the identification code of the at least one game, or alternatively, the second user may initiate the identification code being transferred, e.g., via an infrared port, to the first user.

Once the product is identified, the portable device 100 may use communications protocols including but not limited to Wi-Fi (a, b, c d, n, x), mobile phone communications such as GSM, CDMA, FOMA, etc., infrared communications, cabled communications, Bluetooth communications, satellite communications, to transmit the identification code to a remote server on the global computer network (GCN), e.g., the Internet (step 404). It is to be appreciated the device 100 may use any one or a combination protocols to transmit the identification code to the server 304. For example, the device 100 may employ a telecommunication protocol to transmit the identification code via the communication module 140. In another embodiment, the device 100 may communicate to the server 304 via the same wireless access point 314 that broadcast the list of available content, e.g., a hot spot in a retail location.

The server 304 may be maintained by a vendor associated with the product. For example, in the case of identifying a Warner Brothers™ DVD movie, the server may be a Warner Brothers server connected to a Warner Brothers website. However, the server may also be a vendor not associated or even competing with the product. For example, if the product is a Warner Brothers™ DVD movie, the server may be an e-commerce site such as Amazon.com that offers DVD movies from many companies including Warner Brothers.

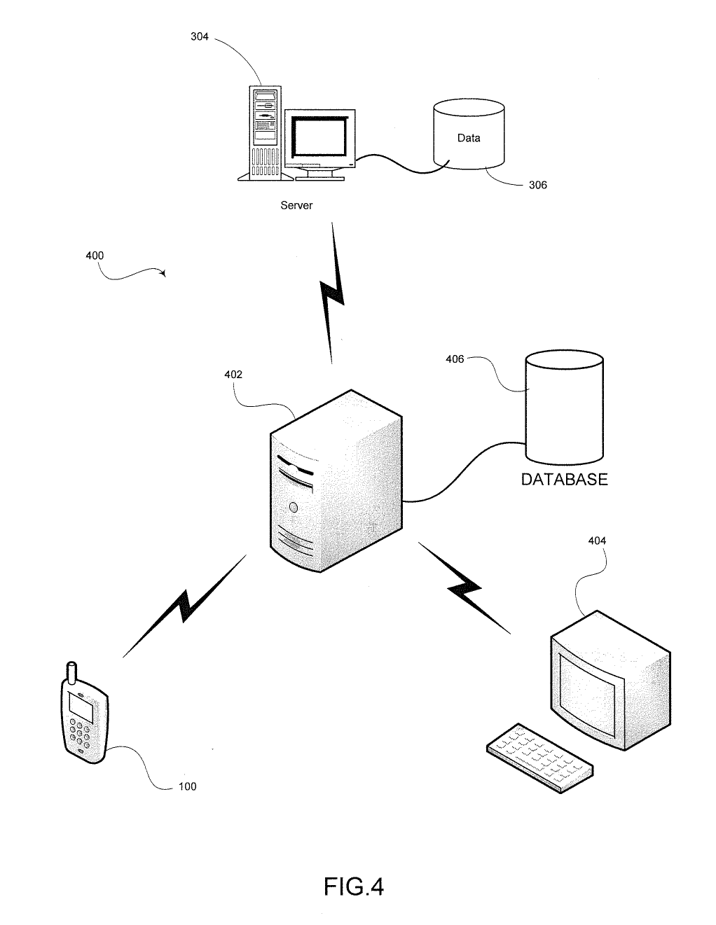

FIG. 4 is a diagram illustrating a retail system 400 according to various implementations of the present disclosure. As shown, the retail system 400 includes the portable digital device 100 (as shown in FIGS. 1-3), a retailer device 402, and a receipt verification device 404. In some implementations, the retail system 400 may include the server 304 shown in FIG. 3, wherein the server 304 may be configured to record electronic receipts related to purchases made at one or more retail stores. The server 304 may be configured to store receipts from all retails stores of a particular company or from multiple companies. The retail system 400 also includes a database 406, which may be connected to the retailer device 402 with respect to embodiments in which receipts and/or product information is stored locally or connected to the server 304 with respect to embodiments in which receipts and/or product information is stored remotely.

The portable digital device 100 may be referred to in this embodiment as a portable customer device, which is utilized by a customer for the purpose of performing a self check-out procedure for purchasing one or more goods and/or services. The term “product” used herein may refer to one or more tangible items that may be purchased, or, in some embodiments, may refer to one or more services to be performed for the customer.

The combination of the retailer device 402, receipt verification device 404, and database 406 may be associated with any business or retail establishment that offers goods and/or services that can be purchased by the customer. In some embodiments, various combinations of the retailer device 402, receipt verification device 404, and database 406 may be integrated within a single device and/or housing. The retailer device 402 may be configured as the terminal 316 shown in FIG. 3 or as a point-of-sale device and may communicate with other devices via the communications network 302. For instance, the retailer device 402 may be associated with the server 304, which, in these implementations, may represent a server configured to serve multiple retailer devices of a franchise or other corporation having multiple locations. As shown in FIG. 4, retailer device 402 is also configured to communicate directly with the portable customer device 100, such as by Wi-Fi, Bluetooth™, or other short range connectivity technology. In addition, the retailer device 402 may also be configured to communicate directly with the receipt verification device 404, using short range wireless connectivity technology or a hardwired connection.

In operation, the scanning module 124 of the portable customer device 100 may be configured to enable the customer to scan a code (e.g., a bar code) associated with a product. The portable customer device 10 may then prompt the customer to enter an action to be taken with respect to that product. For example, the customer may wish to add the product to an electronic or virtual shopping cart. If the product is added, the portable customer device 100 may then prompt the customer to place the scanned item into a physical shopping cart, such as one available within a retail store where the items are offered for sale.

If an item is added to the electronic cart and the customer decides at a later time not to purchase the item, the customer may scan the item again. In this case, the portable customer device 100 may give the customer the option of removing the item from the electronic shopping cart. When an item is removed, the portable customer device 100 instructs the customer to physically remove the item from the physical shopping cart and return the item to the shelf or other area where the item was originally picked up.

The customer may also be interested in receiving additional information about a product. In this case, the customer may scan a code related to the product and select an option to view product information. In response to this selection, the portable customer device 100 is configured to send a short range signal to the retailer device 402 to request to view information about the specific product. The retailer device 402 may be configured to retrieve product information from the database 406 and then send the information to the portable customer device 100.

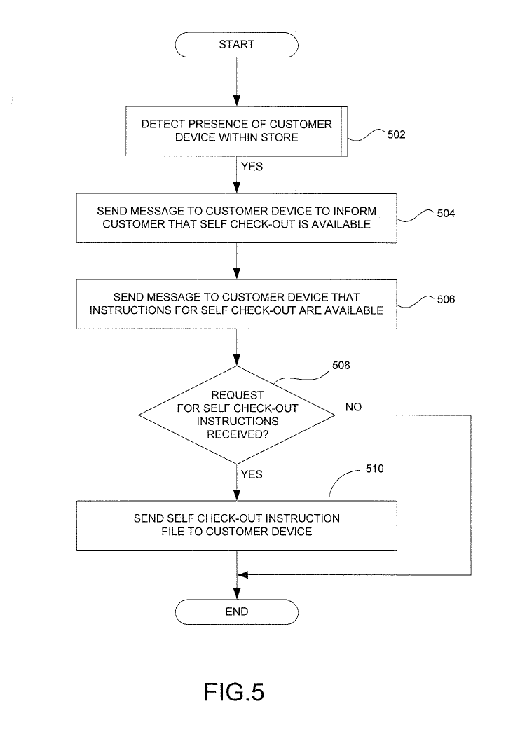

FIG. 5 is a flow diagram showing an embodiment of a method that may be performed by the retailer device 402 shown in FIG. 4. This method may be an optional feature of the retailer device 402 or may be omitted in some embodiments. As illustrated in this embodiment, the method includes detecting the presence of a customer device (e.g., the portable customer device 100) within the premises of a store, as indicated in block 502. Detecting presence may be performed by receiving an RFID signal from the customer device, receiving a wireless beacon signal, or by other means. According to block 504, the method includes sending a message (i.e., from the retailer device 402) to the customer device to inform the customer that a self check-out process is available. As indicated in block 506, another message is sent to the customer device to inform the customer that instructions for how to perform the self check-out process are also available. If the customer wants instructions to learn how the self check-out process is to be executed, the customer may enter a request to receive the instructions from the retailer device 402. Decision block 508 includes determining whether or not a request to view self check-out instruction has been received from the portable customer device. If so, the method proceeds to block 510, which indicates that the retailer device 402 sends the self check-out instructions, or a file containing the instructions, to the customer device.

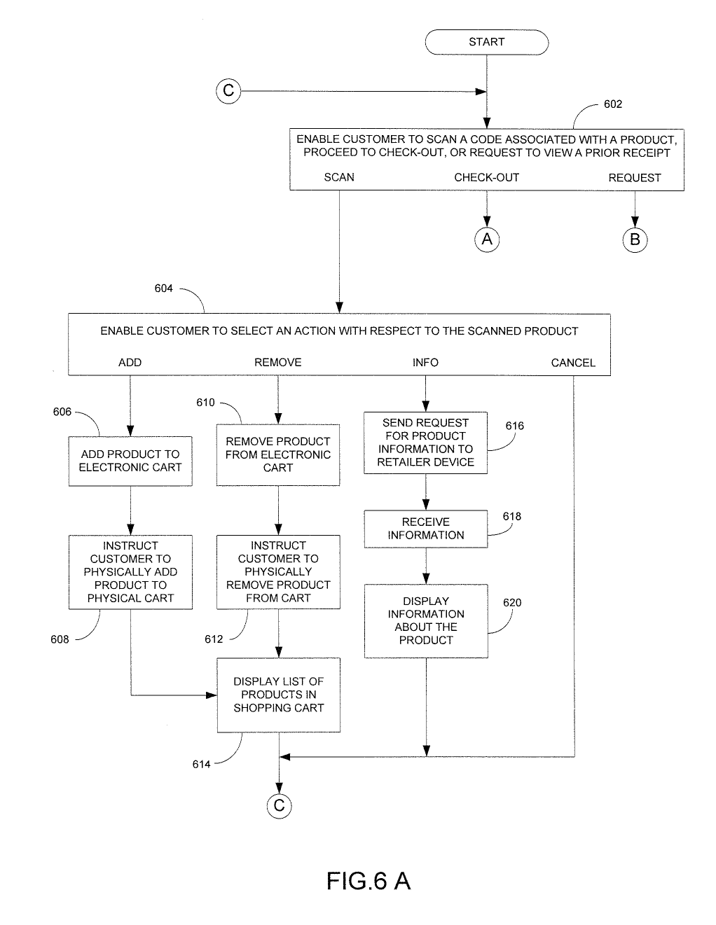

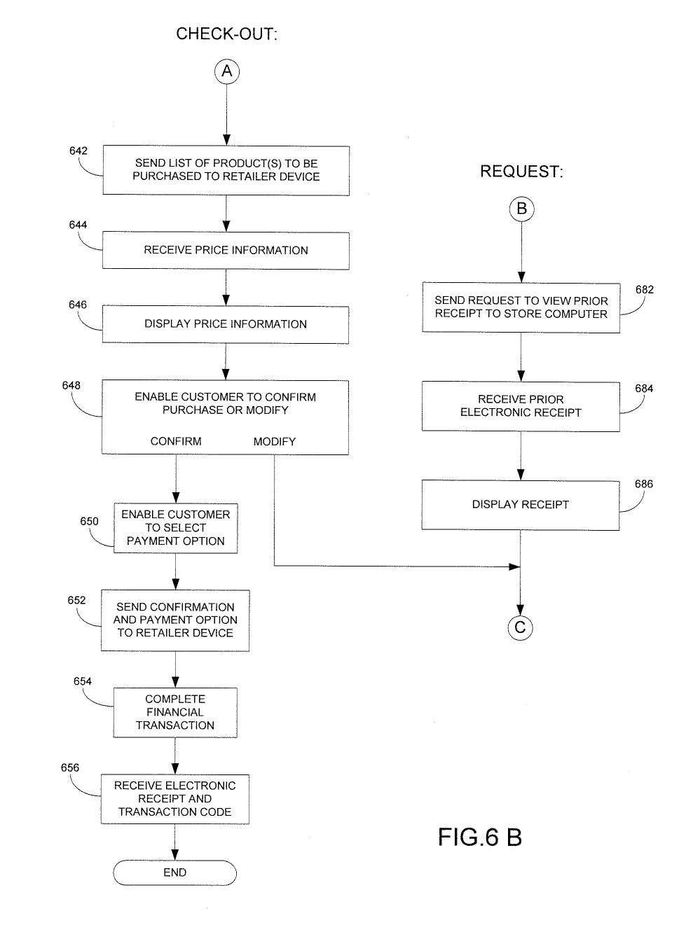

FIGS. 6A and 6B, in combination, represent a block diagram showing an embodiment of a method that may be performed, for example, by the portable customer device 100. As indicated in block 602, the method includes enabling a customer (e.g., utilizing the portable customer device 100) to perform or select a number of option. The customer may choose to scan a code associated with a product (i.e., “scan”), proceed to a check-out routine (i.e., “check-out”), or request to view a prior electronic receipt (i.e., “request”), such as an electronic receipt previously stored by the retailer device in a database. If the customer chooses to proceed to check-out or request a receipt, the method proceeds to the respective branches shown in FIG. 6B, as described in more detail below.

If the customer scans a product's code, the method proceeds to block 604. As indicated in block 604, the customer is enabled to select an action to be performed with respect to the scanned product. For example, the customer may select from options to add the product to or remove the product from an electronic shopping cart. Alternatively, the customer may wish to receive information about the product or cancel the operations with respect to the scanned product.

If the customer decides to add the scanned product, the customer may select the “add” option in block 604. In response, the method proceeds to block 606, where the product is added to the electronic shopping cart. As indicated in block 608, the customer is also instructed to physically add the product to a physical shopping cart, such as a cart or basket typically provided by the store for use by the customers.

If the customer scans an item that has already been added to the electronic shopping cart, the customer may choose to scan the item again. In this case, the customer may be given the choice to “remove” the item, as indicated in block 604. When the user selects to remove an item, the method proceeds to block 610 and the scanned product is removed from the electronic shopping cart. Also, the customer is instructed to physically remove the product from the physical shopping cart, as indicated in block 612. After adding or removing items, block 614 indicates that the method includes displaying the list of products that are currently in the electronic shopping cart.

If the customer desires to receive information about the scanned product (i.e., by selecting “info” in block 604), the method proceeds to block 616. As indicated in block 616, a request is sent (e.g., transmitted wirelessly by the portable customer device 100) to the retailer device 402. As indicated in block 618, the portable customer device 100 may then receive the product information from the retailer device 402 in response to the request. As indicated in block 620, the product information is displayed. For example, the information may be displayed on a display device, such as a display screen, of the portable customer device 100. After adding, removing, receiving product information, or canceling (i.e., by selecting “cancel” in block 604), the method returns to block 602 and may be repeated again.

As shown in FIG. 6B, a check-out routine and request routine may be performed in response to a selection by the customer with respect to block 602. If the customer selects to proceed to check-out (i.e., by selecting “check-out” in block 602), the method goes to block 642. Block 642 indicates that a list of the product(s) to be purchased is sent to the store computer (e.g., the retailer device 402). The customer device then receives a total price for the product(s) from the retailer device 402 (block 644) and displays the total price on a display device (block 646). The total price may also include sales tax and/or other taxes or fees associated with the purchase.

As indicated in block 648, the customer may then review the list of products and the total price to determine whether to “confirm” the purchase or to “modify” the purchase list. If the customer chooses to modify, the method returns back to block 602 to allow the adding or removing of products. If the customer confirms the purchase, the method goes to block 650, which indicates that the customer is prompted and enabled to select an appropriate payment option from one or more options. In some embodiments, payment options may be pre-stored for selection, in either encrypted or unencrypted form. However, according to other embodiments, the customer may enter information regarding a new payment option if desired. Any newly entered payment options may then be used in future purchases. As indicated in block 652, a confirmation of the purchase and the selected payment option are sent to the retailer device. As indicated in block 654, the portable customer device 100 communicates with the retailer device 402 to coordinate the completion of the financial transaction. This financial transaction may include transmitting credit account, debit account, checking account, or savings account information to the retailer device 402. The portable customer device 100 may then receive an electronic receipt from the retailer device 402, as indicated in block 656. In one embodiment, the electronic receipt is also e-mailed to an e-mail address of the customer. The customer's e-mail address may be entered during the transaction or may be pre-stored in the portable customer device 100 with the payment information. The electronic receipt may also be stored in the database 406 or other remote server and/or database for later access by the customer.

If the customer chooses in block 602 (FIG. 6A) to request to view a prior receipt (i.e., by selecting “request”), the method jumps to block 682. As indicated in block 682, the customer device sends a request to view a specific prior electronic receipt, which may be identified by the customer's name or other purchasing information. The request to view the electronic receipt is sent to the retailer device 402, which may retrieve the receipt from a database. As indicated in block 684, the portable customer device 100 receives the prior electronic receipt from the retailer device 402, and then the portable customer device 100 may display the electronic receipt on a display device (block 686). At this point, the method returns to block 602 and the steps may be repeated according to the customer's selections until the final purchase process is completed and the electronic receipt is received (block 656).

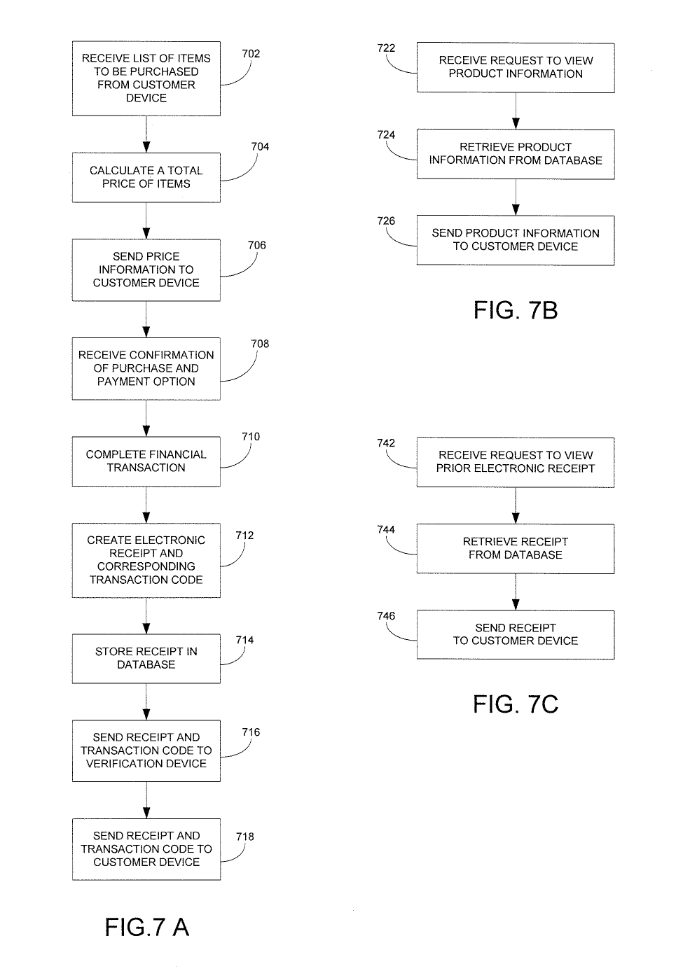

FIGS. 7A, 7B, and 7C are flow diagrams illustrating various embodiments of methods that may be performed by the retailer device 402. FIG. 7A is directed to a method for performing a purchasing process with a customer device, such as the portable customer device 100. FIG. 7B is directed to a method for handling a request to view product information and FIG. 7C is directed to a method for handling a request to view a prior electronic receipt.

As illustrated in FIG. 7A, block 702 indicates that the retailer device is configured to receive, from the customer device, a list of items to be purchased. The method further includes calculating a total price of the product(s) and/or service(s), as indicated in block 704. The price may also include tax and/or other charges. As indicated in block 706, the method includes sending the price information to the customer device for the customer's review. Block 708 indicates that the method may then receive a confirmation of the purchase and payment options for paying for the merchandise. In block 710, the retailer device coordinates with the customer device to complete the financial transaction, which may involve determining whether sufficient funds are held in the account selected in the payment option information from the customer device.

As indicated in block 712, an electronic receipt is created. The electronic receipt may include information that might normally be on a regular paper receipt, such as information identifying products being purchased, quantity, price, date, time, store information, customer's credit information, etc. Also in block 712, a transaction code is created that is unique to the specific purchase. The transaction code may be used to identify the specific electronic receipt. After these things are created, the method includes storing the electronic receipt in a database, as indicated in block 714.

As indicated in block 716, the method includes sending the electronic receipt and transaction code to a verification device, such as receipt verification device 404 shown in FIG. 4. The receipt and transaction code may be sent by a wireless transmission or along hardwired cables. As indicated in block 718, the method includes sending the electronic receipt and transaction code to the customer device. The electronic receipt received by the customer may be saved for the customer's records. Also, the customer's copy of the transaction code can be displayed on the customer device for verification purposes when the customer is leaving the store. According to various implementations of the store's security procedures, the customer may be asked to show the transaction code to store personnel before leaving the store with the purchased products. The store personnel may utilize the receipt verification device 404 to retrieve the receipt associated with the respective transaction code and compare the items that have been purchased with the items that the customer is carrying out of the store. If the customer intentionally or inadvertently tries to leave the store with items that have not been properly purchased using the self check-out procedure, then the store personnel may observe the discrepancies and work to resolve them.

FIG. 7B is a flow diagram of an embodiment of a method for handling requests to view product information, which may also be performed by the retailer device 402. As indicated in block 722, a request is received to view product information. The product information may include a description of the product, such as weight, dimensions, color, speed, compatibility requirements, features, capacities, etc. Also, the product information may include price, discounts available, etc. In response to receiving the request, the method includes retrieving the requested product information from a database, as indicated in block 724. As described in block 726, the method includes sending the product information to the customer device from which the request was received.

FIG. 7C is a flow diagram of an embodiment of a method for handling requests to view previously stored electronic receipts, which may also be performed by the retailer device 402. Occasionally, a customer's receipts, even electronic receipts, may be lost or deleted. In some situations, the customer may wish to view a previously stored electronic receipt, which may be saved in the store's database, such as to return merchandise or for other reasons. The customer may return to the store where the items were purchased, or, according to some embodiments, may return to any facility that is affiliated with that store and may have access to the database where the prior electronic receipts are stored. The customer may also access the electronic receipt by accessing the remote server containing the receipt.

As indicated in block 742, a request to view a prior electronic receipt is received. In response to receiving the request, the method includes retrieving the requested receipt from a database, as indicated in block 744. As described in block 746, the method includes sending a copy of the electronic receipt to the customer device from which the request was received.

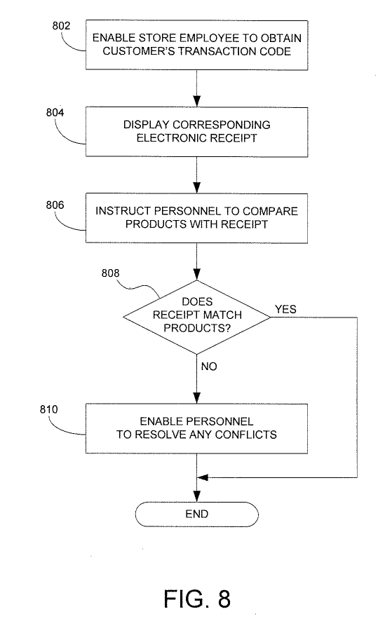

FIG. 8 is a flow diagram illustrating an embodiment of a method for verifying a purchasing process involving self check-out procedures. The method of FIG. 8, for example, may be performed by the receipt verification device 404 shown in FIG. 4. As indicated in block 802, a store employee is prompted and/or enabled to obtain a transaction code for a customer preparing to leave the store. The transaction code may be obtained in several ways. For example, the receipt verification device 404 may include a scanning device that is configured to scan a transaction code displayed on a display screen of the customer device. The displayed transaction code is code that the customer receives when the self check-out procedure is completed. Another way of obtaining the transaction code may be to enter the transaction code using an input device associated with the receipt verification device 404, e.g., the input device may be a keyboard, a virtual keyboard, a character recognition input device, a voice recognition input device, etc.

As indicated in block 804, the method includes displaying the electronic receipt corresponding to the obtained transaction code. The receipt may be displayed on a display screen associated with the receipt verification device 404 to be viewed by the store employee. According to block 806, the store employee is instructed to compare the products being taken by the customer with the products listed on the receipt. As indicated in decision block 808, the employee is prompted to indicate whether or not the receipt matches the products being taken. If they match, the customer is permitted to leave and the method ends. However, if the receipt does not match the products, the employee is prompted and/or enabled to resolve any conflicts with regard to the discrepancy.

It is to be appreciated that the receipt verification device 404 can take many forms including a tablet type computing device such as an IPad™ device from Apple Computers, Inc. of Cupertino, California. In other embodiments, the receipt verification device 404 could take the same form as portable customer device 100, wherein the employee may verify the receipt by scanning each item taken by the customer.

While the disclosure has been shown and described with reference to certain preferred embodiments thereof, it will be understood by those skilled in the art that various changes in form and detail may be made therein without departing from the spirit and scope of the disclosure as defined by the appended claims.

1. A software program stored on a non-transitory computer-readable medium and configured to be executed by a processing device, the software program comprising:
logic adapted to enable a user of a portable customer owned device to utilize the portable customer owned device to capture an image of a product and resolve product identity;
logic adapted to enable the user to add the product to an electronic shopping cart; and
logic adapted to instruct the user to physically add the product to a physical cart;
logic adapted to enable the user to initiate a check-out procedure;
logic adapted to send a list of one or more products added to the electronic shopping cart from the portable customer owned device to a retailer device over a communication network, wherein the communication network is not wholly operated and controlled by the retailer and partially controlled and operated by the portable customer device;
logic adapted to receive a total price for the one or more products from the retailer device over the communication network; and
logic adapted to display the total price.

2. The software program of claim 1, wherein the portable customer owned device is a mobile phone.

3. The software program of claim 1, further comprising:
logic adapted to enable the user to capture an image of a product and resolve product identity a second time;
logic adapted to enable the user to remove the product from the electronic shopping cart; and
logic adapted to instruct the user to physically remove the product from the physical cart.

4. The software program of claim 1, further comprising:
logic adapted to enable the user to capture an image of a second product and resolve the second product's identity;
logic adapted to enable the user to request information about the second product;
logic adapted to send a request for product information to a retailer device;
logic adapted to receive the requested information from the retailer device; and
logic adapted to display the product information on the portable customer owned device.

5. The software program of claim 4, wherein the product information includes a price of the second product or other information relevant to the product.

6. (canceled)

7. The software program of claim 6, further comprising logic adapted to enable the user to change the quantity of the one or more products in the electronic shopping cart.

8. The software program of claim 6, further comprising: logic adapted to enable the user to confirm the purchase of the one or more products.

9. The software program of claim 8, further comprising:
logic adapted to enable the user to select a payment option from one or more payment options upon confirmation of the purchase;
logic adapted to send confirmation of the purchase and the selected payment option to the retailer device;
logic adapted to coordinate with the retailer device to complete the check-out procedure;
logic adapted to receive an electronic receipt and a scannable transaction code from the retailer device; and
logic adapted to display the scannable transaction code.

10. The software program of claim 9, wherein the one or more payment options includes payment information pre-stored on the portable customer owned device.

11. The software program of claim 1, further comprising:
logic adapted to enable the user to request to view a prior electronic receipt;
logic adapted to send a request for the prior electronic receipt to the retailer device;
logic adapted to receive the prior electronic receipt from the retailer device; and
logic adapted to display the prior electronic receipt on the portable customer device.

12. A retail system comprising:
a retailer device associated with a business that allows a customer to purchase goods or services, the retailer device comprising a receiver configured to receive signals from a portable customer owned device associated with the customer over a communication network, wherein the communication network is not wholly operated and controlled by the retailer and partially controlled and operated by the portable customer device, the receiver configured to receive signals related to a list of items to be purchased by the customer, the retailer device also comprising a processor configured to coordinate with the portable customer owned device to complete a purchase of the listed items, the processor further configured to create an electronic receipt containing information of the purchase and create a transaction code corresponding to the electronic receipt; and
a receipt verification device in communication with the retailer device, the receipt verification device comprising an input device configured to enable store personnel to obtain the transaction code, the receipt verification device further comprising a display device configured to display an electronic receipt corresponding to the obtained transaction code.

13. The retail system of claim 12, wherein the receiver is configured to receive the signals from the portable customer owned device over a wireless channel.

14. The retail system of claim 12, wherein the retailer device and the receipt verification device communicate with each other over a wireless channel.

15. The retail system of claim 12, wherein the processor is further configured to calculate a total price for the items to be purchased.

16. The retail system of claim 15, wherein, to complete the purchase, the retailer device further comprises a financial account access device configured to receive payment of the total price from a selected customer account.

17. The retail system of claim 16, wherein the selected customer account is pre-stored on the portable customer owned device.

18. The retail system of claim 12, wherein the input device is a scanner configured to scan a transaction code displayed on a screen of the portable customer owned device.

19. The retail system of claim 12, wherein the retailer device and receipt verification device are integrated within one device.

20. The retail system of claim 12, wherein the receiver is further configured to:
detect the presence of the portable customer owned device within the premises of the business; and
send self check-out instructions to the portable customer owned device.

21. The retail system of claim 12, further comprising a database configured to store information associated with the goods or services offered by the business, wherein the receiver is further configured to receive a request to view the information associated with one of the goods or services, the processor being further configured to retrieve the requested information from the database, the receiver being further configured to send the requested information to the portable customer owned device.

22. The retail system of claim 12, further comprising a database configured to store a prior electronic receipt from a previous purchase by the customer, wherein the receiver is further configured to receive a request to view the prior electronic receipt, the processor being further configured to retrieve the prior electronic receipt from the database, the receiver being further configured to send the prior electronic receipt to the portable customer owned device.

23. A method comprising:
coordinating with a customer using a portable customer owned device to perform a self check-out procedure for making a purchase from a retail establishment offering merchandise for sale;
creating an electronic receipt summarizing the purchase and a transaction code to be associated with the electronic receipt by the portable customer owned device;
enabling store personnel to obtain the transaction code from the customer through the portable customer owned device over a communication network, wherein the communication network is not wholly operated and controlled by the retailer and partially controlled and operated by the portable customer device;
displaying an electronic receipt associated with the obtained transaction code on the portable customer owned device to allow the store personnel to compare the merchandise listed on the electronic receipt with merchandise that the customer is taking from the retail establishment.

24. The method of claim 23, further comprising the steps of:
receiving a list of products to be purchased by the customer;
calculating a total price of the products; and
sending price information to the portable customer owned device.

25. The method of claim 24, wherein coordinating with the customer further comprises receiving a confirmation of the purchase and a payment option from the portable customer owned device.

26. The method of claim 25, wherein the payment option is pre-stored on the portable customer owned device.

27. The method of claim 23, further comprising the step of storing the electronic receipt in a database.

28. The method of claim 23, further comprising the step of sending the electronic receipt and transaction code to the portable customer device, the portable customer owned device being configured to display the transaction code on a display screen thereof.

29. The method of claim 28, further comprising the step of sending the electronic receipt and transaction code to a receipt verification device associated with the retail establishment.

30. The method of claim 29, wherein enabling the store personnel to obtain the transaction code further comprises the step of enabling the store personnel to scan the transaction code displayed on the display screen of the portable customer owned device.

31. The software program of claim 1, wherein symbology is scanned when capturing the image, the symbology capable of including a bar code.

32. A method for enabling customers to perform self-checkout, the method comprising:
a user capturing an image of a product and resolving product identity using a portable customer owned device;
previewing information on the product using a portable customer owned device; and
receiving instructions to place the product in a physical cart;
enabling the user to initiate a check-out procedure;
transmitting a list of one or more products added to the electronic shopping cart to a retailer device over a communication network, wherein the communication network is not wholly operated and controlled by the retailer and partially controlled and operated by the portable customer device;
receive a total price for the one or more products from the retailer device over the communication network; and
displaying the total price on the portable customer owned device;
performing a purchase transaction of the one or more products based on the total price.

33. The method of claim 32, wherein a preview of information on the product be one or more formats including audio, video, text, or hyperlinks to other websites on the Internet.
